(19) United States
(12) Patent Application Publication
(10) Pub. No.: US 2024/0085039 A1
(43) Pub. Date: Mar. 14, 2024

(54) AIR CONDITIONER AND ELECTROSTATIC PRECIPITATOR

(71) Applicant: SAMSUNG ELECTRONICS CO., LTD., Suwon-si (KR)

(72) Inventors: Myungsoo KANG, Suwon-si (KR); Hyongsoo NOH, Suwon-si (KR); Myungseob SONG, Suwon-si (KR); Kyuho SHIN, Suwon-si (KR); Joonoh SHIN, Suwon-si (KR)

(73) Assignee: SAMSUNG ELECTRONICS CO., LTD., Suwon-si (KR)

(21) Appl. No.: 18/235,185

(22) Filed: Aug. 17, 2023

Related U.S. Application Data
(63) Continuation of application No. PCT/KR2023/011587, filed on Aug. 7, 2023.

(30) Foreign Application Priority Data
Sep. 8, 2022 (KR) 10-2022-0114541
Dec. 26, 2022 (KR) 10-2022-0185037
Jul. 18, 2023 (KR) 10-2023-0093448

(51) Int. Cl. F24F 8/192; B03C 3/09; B03C 3/36; B03C 3/41; F24F 1/0353; F24F 8/30

(52) U.S. Cl. CPC F24F 8/194; B03C 3/09; B03C 3/368; B03C 3/41; F24F 1/0353; F24F 8/30; B03C 2201/08; B03C 2201/10

(57) ABSTRACT

An air conditioner including a housing including a suction panel; a fan disposed inside the housing and configured to generate an air flow which is sucked into the housing through the suction panel to flow in a first direction from upstream to downstream, the suction panel being perpendicular to the first direction; and an electrostatic precipitator disposed inside the housing and including a discharge electrode configured to receive a voltage and to generate ions toward the suction panel, and an upstream electrode disposed upstream of the discharge electrode with respect to the first direction, grounded to form an electric field with the discharge electrode, and disposed between the discharge electrode and the suction panel, wherein at least a portion of the ions generated from the discharge electrode are passed through the suction panel so as to charge aerosols in air outside the housing.

### CROSS-REFERENCE TO RELATED APPLICATION(S)

This application is a continuation application, under 35 U.S.C. § 111(a), of international application No. PCT/KR2023/011587, filed on Aug. 7, 2023, which claims priority to Korean Patent Application No. 10-2022-0114541, filed on Sep. 8, 2022, Korean Patent Application No. 10-2022-0185037, filed on Dec. 26, 2022, and Korean Patent Application No. 10-2023-0093448, filed on Jul. 18, 2023 in the Korean Intellectual Property Office, the disclosures of which are incorporated by reference herein in their entireties.

### BACKGROUND

### 1. Field

The disclosure relates to an air conditioner and an electrostatic precipitator, and more particularly, to an air conditioner including an electrostatic precipitator.

### 2. Description of Related Art

High-concentration of aerosols in confined spaces such as homes, rooms, shopping malls, factories, and offices may cause problems to people's health. These aerosols may be generated by smoking, cooking, cleaning, welding, grinding, etc., in the confined spaces.

An electrostatic precipitator is a device for removing such aerosols and may be used in an air conditioner having an air cleaning function.

The electrostatic precipitator may include a charger configured to charge aerosols in the air through electric discharge, and a dust collector composed of a high voltage electrode and a low voltage electrode to collect the aerosols charged by the charger.

### SUMMARY

Aspects of embodiments of the disclosure will be set forth in part in the description which follows and, in part, will be apparent from the description, or may be learned by practice of the presented embodiments.

According to an embodiment of the disclosure, an air conditioner may include a housing including a suction panel; a fan disposed inside the housing and configured to generate an air flow which is sucked into the housing through the suction panel to flow in a first direction from upstream to downstream, the suction panel being perpendicular to the first direction; and an electrostatic precipitator disposed inside the housing and including a discharge electrode configured to receive a voltage and to generate ions toward the suction panel, and an upstream electrode disposed upstream of the discharge electrode with respect to the first direction, grounded to form an electric field with the discharge electrode, and disposed between the discharge electrode and the suction panel, wherein at least a portion of the ions generated from the discharge electrode are passed through the suction panel so as to charge aerosols in air outside the housing.

According to an embodiment of the disclosure, the upstream electrode may extend along a plane perpendicular to the first direction to at least partially cover the suction panel.

According to an embodiment of the disclosure, the upstream electrode may include a hollow, and an electrode member forming an outer circumference of the hollow and having a length extending along the plane perpendicular to the first direction.

According to an embodiment of the disclosure, the discharge electrode may include a first discharge electrode, and a second discharge electrode spaced apart from the first discharge electrode in a second direction perpendicular to the first direction, the upstream electrode may include a first upstream electrode disposed so that a center of the first upstream electrode is disposed in a position corresponding to the first discharge electrode along the first direction, and a second upstream electrode disposed so that a center of the second upstream electrode is disposed in a position corresponding to the second discharge electrode along the first direction, the second upstream electrode being spaced apart from and disposed adjacent to the first upstream electrode, and the air conditioner may further include a through hole extending between the first upstream electrode and the second upstream electrode.

According to an embodiment of the disclosure, the discharge electrode may include a first discharge electrode, and a second discharge electrode spaced apart from the first discharge electrode in a second direction perpendicular to the first direction, the upstream electrode may include a first upstream electrode disposed so that a center of the first upstream electrode is disposed in a position corresponding to the first discharge electrode along the first direction, and a second upstream electrode disposed so that a center of the second upstream electrode is disposed in a position corresponding to the second discharge electrode along the first direction, the second upstream electrode disposed adjacent to the first upstream electrode, and the electrode member of the second upstream electrode may extend from the electrode member of the first upstream electrode.

According to an embodiment of the disclosure, the electrode member may be configured in a polygonal ring shape.

According to an embodiment of the disclosure, the electrode member may be configured in a circular ring shape.

According to an embodiment of the disclosure, a cross section of the electrode member may have a circular shape.

According to an embodiment of the disclosure, the upstream electrode may be configured in a rod shape.

According to an embodiment of the disclosure, the upstream electrode may be disposed to be in contact with the suction panel.

According to an embodiment of the disclosure, the electrostatic precipitator may further include a downstream electrode disposed downstream of the discharge electrode with respect to the first direction, and the downstream electrode may be grounded to form an electric field with the discharge electrode.

According to an embodiment of the disclosure, the downstream electrode may have a mesh shape.

According to an embodiment of the disclosure, at least a portion of the downstream electrode may include a conductive material.

### BRIEF DESCRIPTION OF THE DRAWINGS

These and/or other embodiments of the disclosure will become apparent and more readily appreciated from the following description of the embodiments, taken in conjunction with the accompanying drawings of which:

FIG. 1 is a perspective view illustrating a front side of an air conditioner according to an embodiment of the disclosure;

FIG. 2 is a perspective view illustrating a rear side of the air conditioner according to an embodiment of the disclosure;

FIG. 3 is an exploded perspective view of a schematic configuration of the air conditioner according to an embodiment of the disclosure;

FIG. 4 is a perspective view schematically illustrating an inside of the air conditioner according to an embodiment of the disclosure;

FIG. 5 is a cross-sectional view of a portion of the air conditioner according to an embodiment of the disclosure;

FIG. 6 is a cross-sectional view illustrating movement of ions in FIG. 5;

FIG. 7 is a perspective view schematically illustrating the inside of the air conditioner according to an embodiment of the disclosure;

FIG. 8 is a cross-sectional view of a portion of the air conditioner according to an embodiment of the disclosure;

FIG. 9 is a cross-sectional view illustrating movement of ions in FIG. 8;

FIG. 10 is a rear-view illustrating an air conditioner according to an embodiment of the disclosure;

FIG. 11 is a rear-view illustrating an air conditioner according to an embodiment of the disclosure;

FIG. 12 is a rear-view illustrating an air conditioner according to an embodiment of the disclosure;

FIG. 13 is a rear-view illustrating an air conditioner according to an embodiment of the disclosure;

FIG. 14 is a rear-view illustrating an air conditioner according to an embodiment of the disclosure;

FIG. 15 is a perspective view illustrating an air conditioner according to an embodiment of the disclosure;

FIG. 16 is a perspective view schematically illustrating an inside of the air conditioner according to an embodiment of the disclosure;

FIG. 17 is a cross-sectional view illustrating movement of ions in a portion of the air conditioner according to an embodiment of the disclosure;

FIG. 18 is a perspective view schematically illustrating the inside of the air conditioner according to an embodiment of the disclosure; and

FIG. 19 is a perspective view schematically illustrating the inside of the air conditioner according to an embodiment of the disclosure.

### DETAILED DESCRIPTION

Embodiments described in the disclosure and configurations shown in the drawings are merely examples of the embodiments of the disclosure, and may be modified in various different ways at the time of filing of the present application to replace the embodiments and drawings of the disclosure.

In addition, the same reference numerals or signs shown in the drawings of the disclosure indicate elements or components performing substantially the same function. Shapes and sizes of elements in the drawings may be exaggerated for clear description.

Also, the terms used herein are used to describe the embodiments and are not intended to limit and/or restrict the disclosure. The singular forms “a,” “an” and “the” are intended to include the plural forms as well, unless the context clearly indicates otherwise. In this disclosure, the terms “including”, “having”, and the like are used to specify features, numbers, steps, operations, elements, components, or combinations thereof, but do not preclude the presence or addition of one or more of the features, elements, steps, operations, elements, components, or combinations thereof.

It will be understood that, although the terms first, second, third, etc., may be used herein to describe various elements, but elements are not limited by these terms. These terms are only used to distinguish one element from another element. For example, without departing from the scope of the disclosure, a first element may be termed as a second element, and a second element may be termed as a first element. The term of “and/or” includes a plurality of combinations of relevant items or any one item among a plurality of relevant items.

In the following detailed description, the terms of “front side”, “upper portion”, “lower portion”, “left side”, “right side” and the like may be defined by the drawings, but the shape and the location of the component is not limited by the term.

Embodiments of the disclosure may provide an air conditioner and an electrostatic precipitator including an improved structure to charge air outside a housing. Embodiments of the disclosure may provide an air conditioner and an electrostatic precipitator having an improved air charging efficiency. Embodiments of the disclosure may provide an air conditioner and an electrostatic precipitator capable of increasing a degree of freedom in design of the air conditioner. Embodiments of the disclosure may provide an air conditioner and an electrostatic precipitator capable of increasing a degree of freedom in installation of the air conditioner.

The disclosure will be described more fully hereinafter with reference to the accompanying drawings.

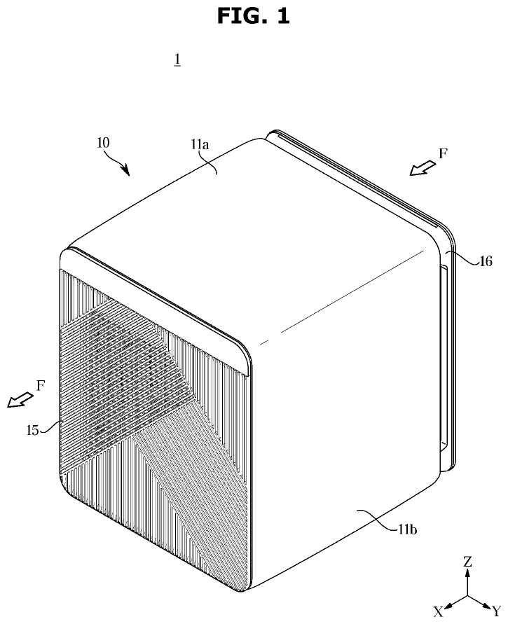

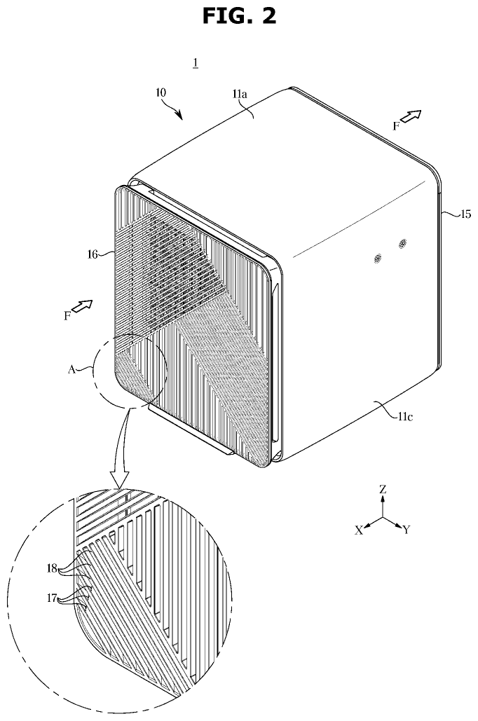

FIG. 1 is a perspective view illustrating a front side of an air conditioner according to an embodiment of the disclosure. FIG. 2 is a perspective view illustrating a rear side of the air conditioner according to an embodiment.

An electrostatic precipitator is a device for removing airborne aerosols generated by activities such as smoking, cooking, cleaning, welding, and grinding in a certain space. The electrostatic precipitator may be installed inside an apparatus capable of performing an air filtering function, such as an air conditioner.

In addition, although an air purifier, which is a type of air conditioner, is illustrated as an example for convenience of description, the disclosure for collecting aerosols in the air is not limited to the air purifier and may be applied to other air conditioners. For example, the disclosure may also be applied to a cooling and heating apparatus that is different from an air purifier and is other types of air conditioners. Further, the disclosure may be applied to any home appliance as long as a home appliance includes an electrostatic precipitator.

Referring to FIGS. 1 and 2, an air conditioner 1 may include a housing 10. The housing 10 may have a substantially box shape.

The housing 10 may include a cabinet 11 forming an exterior. The cabinet 11 may include an upper cabinet 11a, a left cabinet 11b, a right cabinet 11c, and a lower cabinet 11d. The upper cabinet 11a, the left cabinet 11b, the right cabinet 11c, and the lower cabinet 11d may be integrally formed. The upper cabinet 11a, the left cabinet 11b, the right cabinet 11c, and the lower cabinet 11d may sequentially form upper, left, right, and lower surfaces of the housing 10.

The housing 10 may include a suction panel 16 configured to allow external air to flow into the air conditioner 1. The housing 10 may include a discharge panel 15 configured to discharge air, which is sucked into the housing 10 through the suction panel 16, to an outside.

The housing 10 may be integrally formed. The suction panel 16 and/or the discharge panel 15 may be integrally formed with the cabinet 11. Alternatively, the suction panel 16 and/or the discharge panel 15 may be coupled to the cabinet 11 to form the housing 10.

The suction panel 16 and/or the discharge panel 15 may include plastic.

Meanwhile, air may pass through the housing 10 along a first direction F. The first direction F may be a direction from upstream to downstream of an air flow path. The first direction F may be a direction from the suction panel 16 to the discharge panel 15.

In this drawing, it is illustrated that the suction panel 16 and the discharge panel 15 are vertically disposed with respect to the ground. The air may flow from the rear to the front, and thus the first direction F may be from the rear to the front. That is, the first direction F may be a direction along the X-axis.

However, the disclosure is not limited thereto, and when the suction panel 16 and the discharge panel 15 are disposed horizontally with respect to the ground, the air may flow from the bottom to the top and thus the first direction F may be a direction along the Z-axis from the bottom to the top.

That is, the arrangement structure of the air conditioner 1 is not limited thereto, and the first direction F may be defined as a direction in which air flows from upstream to downstream.

Referring to FIG. 2, the suction panel 16 may extend along a second direction. The second direction may be a direction substantially perpendicular to the first direction F.

In this drawing, because the first direction F is a direction along the X-axis, the second direction may be a direction along the Y-axis and/or the Z-axis. In addition, the second direction may be various directions disposed on a Y-Z plane.

The suction panel 16 may include a cover portion 18 and an opening 17.

Referring to a portion A corresponding to a portion of the suction panel 16 that is enlarged, the cover portion 18 may include a plurality of ribs. The plurality of ribs may extend along the second direction perpendicular to the first direction F. In this drawing, it is illustrated that the plurality of ribs extends in the Z-axis direction and/or in a diagonal direction between the Y-axis and the Z-axis as an example, but the disclosure is not limited thereto. The plurality of ribs may extend along various directions on the Y-Z plane on which the suction panel 16 is disposed. The plurality of ribs may extend in various directions perpendicular to the first direction F.

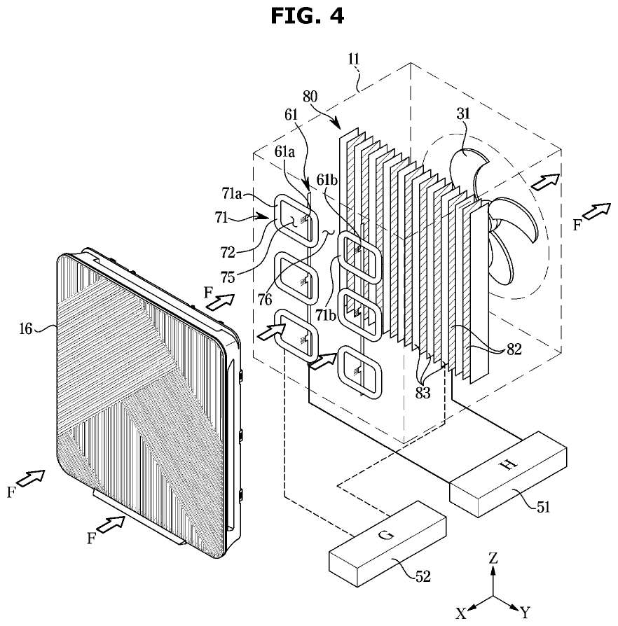

The cover portion 18 may be formed over the entire area of the suction panel 16. The suction panel 16 may be provided without a hole that is separately formed to expose a discharge electrode 61 (refer to FIG. 4) inside the housing 10 to the outside. That is, the cover portion 18 may be provided in a uniform pattern over the entire area of the suction panel 16. Accordingly, aesthetics may be improved by increasing a degree of freedom in the design of the suction panel 16. This will be described later.

The opening 17 may be formed to correspond to the cover portion 18. That is, the opening 17 may be an opening formed between the plurality of ribs of the cover portion 18. Air outside the housing 10 may be sucked into the housing 10 through the opening 17. The opening 17 may be provided in plurality.

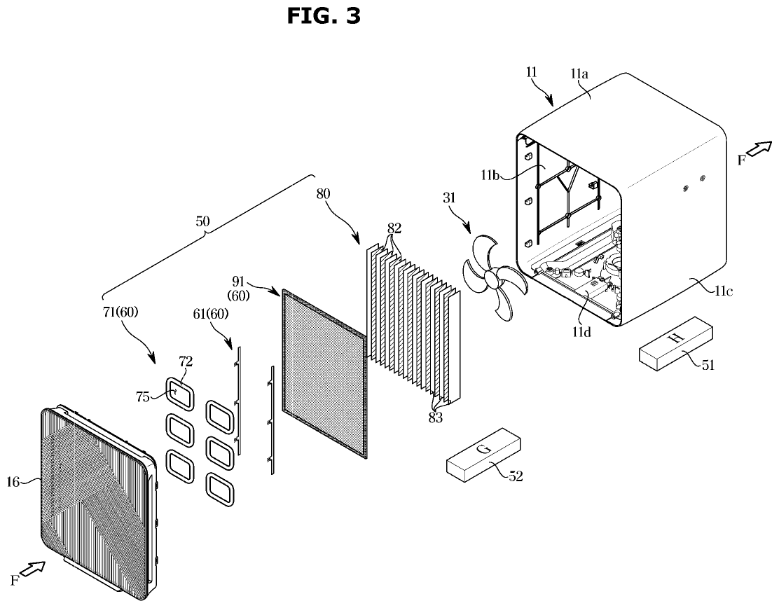

FIG. 3 is an exploded perspective view of a schematic configuration of the air conditioner according to an embodiment.

Referring to FIG. 3, the air conditioner 1 may include a fan 31. The fan 31 may be disposed inside the housing 10. The fan 31 may suck air from outside the housing 10 into the housing 10 through the suction panel 16 and discharge the sucked air to the outside of the housing 10 through the discharge panel 15. The fan 31 may blow air in the first direction F.

The fan 31 may be disposed between the suction panel 16 and the discharge panel 15. The fan 31 may be disposed downstream from the suction panel 16 with respect to the first direction F. The fan 31 may be disposed upstream from the discharge panel 15 with respect to the first direction F.

The air conditioner 1 may include an electrostatic precipitator 50. The electrostatic precipitator 50 may be disposed inside the housing 10. The electrostatic precipitator 50 may filter the air by collecting aerosols in the air.

The electrostatic precipitator 50 may include a charger 60 and a dust collector 80. The charger 60 may charge aerosols in the air. The dust collector 80 may collect and remove the aerosols charged by the charger 60 from the air.

The electrostatic precipitator 50 may be disposed between the suction panel 16 and the discharge panel 15. The electrostatic precipitator 50 may be disposed downstream from the suction panel 16 with respect to the first direction F. The electrostatic precipitator 50 may be disposed upstream from the discharge panel 15 with respect to the first direction F. The electrostatic precipitator 50 may be disposed upstream from the fan 31 with respect to the first direction F.

The charger 60 may be disposed upstream of the dust collector 80 with respect to the first direction F. The charger 60 may be disposed more adjacent to the suction panel 16 than the discharge panel 15.

The air conditioner 1 may include various filter devices (not shown) in addition to the electrostatic precipitator 50. For example, a fine dust collecting filter in the form of a nonwoven fabric formed of polypropylene resin or polyethylene resin and/or a granular activated carbon filter may be selectively provided.

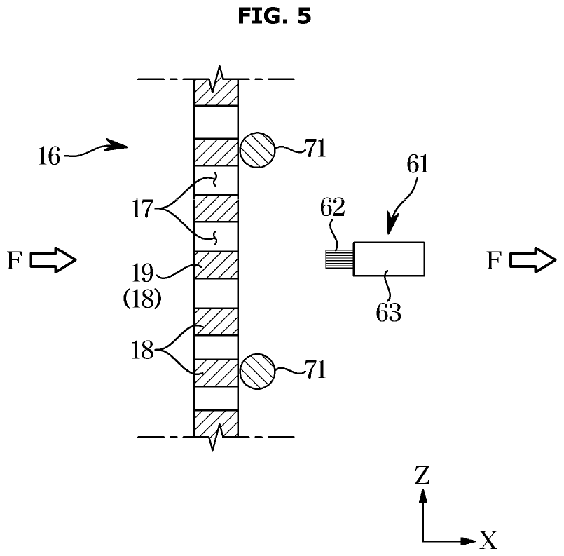

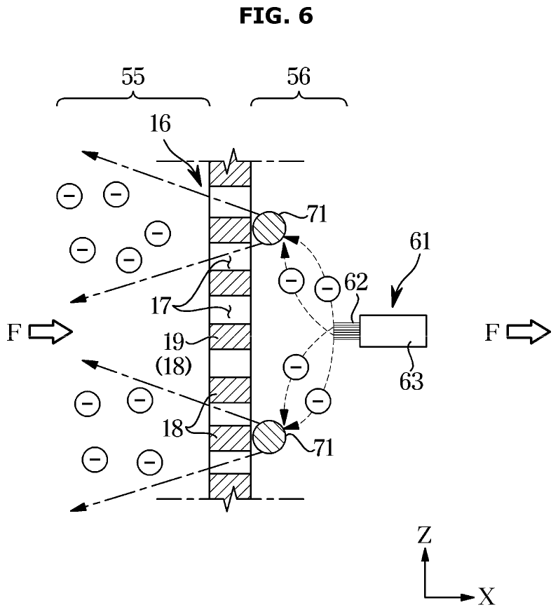

FIG. 4 is a perspective view schematically illustrating an inside of the air conditioner according to an embodiment. FIG. 5 is a cross-sectional view of a portion of the air conditioner according to an embodiment. FIG. 6 is a cross-sectional view illustrating movement of ions in FIG. 5.

In FIG. 4, the cabinet 11 may be indicated by a dotted line and thus a configuration provided inside the housing 10 may be seen.

Referring to FIG. 4, the fan 31 may move air to flow with respect to the first direction F from upstream to downstream.

The charger 60 may include a discharge electrode 61. The discharge electrode 61 may be embedded inside the housing 10. The discharge electrode 61 may generate ions. The discharge electrode 61 may receive a high voltage from a power supplier 51 and generate ions by corona discharge. Hereinafter the voltage applied to the discharge electrode 61 from the power supplier 51 may be referred to as a ‘first voltage’. The discharge electrode 61 may generate negative ions or positive ions by receiving the first voltage.

The discharge electrode 61 may be disposed to generate ions toward the suction panel 16. The discharge electrode 61 may be disposed toward the upstream side of the air flow path. The discharge electrode 61 may be disposed to generate ions in a direction opposite to the first direction F. Ions generated from the discharge electrode 61 may move in a direction opposite to the first direction F.

Referring to FIG. 5, the discharge electrode 61 may include a brush 62. The brush 62 may include a plurality of conductive fibers. The conductive fiber may be provided with carbon fiber or the like.

One end of the brush 62 may be disposed toward the upstream of the air flow path. The other end of the brush 62 may be caulked to a caulking member 63.

However, the disclosure is not limited thereto, and the discharge electrode 61 may be provided with other materials or other shapes. That is, the discharge electrode 61 may be implemented with other structures as long as the discharge electrode 61 is configured to generate ions by receiving a voltage.

Referring to FIG. 4, the discharge electrode 61 may include a first discharge electrode 61a and a second discharge electrode 61b. The second discharge electrode 61b may be spaced apart from the first discharge electrode 61a with respect to the second direction. The second discharge electrode 61b may be spaced apart from the first discharge electrode 61a with respect to the Z-axis direction and/or the Y-axis direction.

The first discharge electrode 61a and/or the second discharge electrode 61b may be disposed parallel to the suction panel 16. The first discharge electrode 61a and the second discharge electrode 61b may be disposed on the same Y-Z plane. A distance between the first discharge electrode 61a and the suction panel 16 with respect to the first direction F may correspond to a distance between the second discharge electrode 61b and the suction panel 16 with respect to the first direction F.

Although six discharge electrodes 61 are illustrated as an example in this drawing, the number of discharge electrodes 61 is not limited thereto.

The charger 60 may include an upstream electrode 71. At least a portion of the upstream electrode 71 may include a metal or a conductive material having electrical characteristics similar to a metal. The upstream electrode 71 may be grounded on a ground 52. The upstream electrode 71 may maintain a voltage of substantially 0V.

That is, the upstream electrode 71 may maintain a lower potential than the discharge electrode 61. Accordingly, a constant potential difference may be formed between the upstream electrode 71 and the discharge electrode 61. An electric field may be formed between the upstream electrode 71 and the discharge electrode 61. High-density ions may be generated between the discharge electrode 61 and the upstream electrode 71.

The upstream electrode 71 may be disposed upstream of the discharge electrode 61 with respect to the first direction F. The upstream electrode 71 may be disposed between the suction panel 16 and the discharge electrode 61. The upstream electrode 71 may be disposed more adjacent to the suction panel 16 than the discharge panel 15.

Ions generated by the discharge electrode 61 may move toward the upstream electrode 71 due to a potential difference. At this time, because the upstream electrode 71 is disposed adjacent to the suction panel 16, the upstream electrode 71 may attract ions, which are moving from the discharge electrode 61, toward the suction panel 16.

The suction panel 16 may include plastic or the like. Ions generated by the discharge electrode 61 may move to the suction panel 16 and accumulate on the suction panel 16. At this time, as the potential of the suction panel 16 increases, the potential difference between the suction panel 16 and the discharge electrode 61 decreases, and thus corona discharge in the discharge electrode 61 may not occur easily.

According to the disclosure, the upstream electrode 71 may be disposed adjacent to the suction panel 16 and thus it is possible to prevent ions from accumulating on the suction panel 16, thereby preventing an increase in the potential of the suction panel 16.

That is, because the upstream electrode 71 and the suction panel 16 maintain a constant potential difference with the discharge electrode 61, the discharge electrode 61 may continuously generate ions by corona discharge.

The upstream electrode 71 may be provided to cover the suction panel 16. The upstream electrode 71 may be provided to maximize an area covering the suction panel 16 to prevent ions generated by the discharge electrode 61 from accumulating on the suction panel 16.

The upstream electrode 71 may extend along the second direction in which the suction panel 16 extends. The upstream electrode 71 may extend along the Y-axis and/or Z-axis. The upstream electrode 71 may extend along various directions perpendicular to the first direction F on the Y-Z plane.

The upstream electrode 71 may be disposed parallel to the second direction in which the suction panel 16 is disposed. That is, the suction panel 16 may be disposed parallel to the Y-axis and/or the Z-axis. The upstream electrode 71 may be disposed on the Y-Z plane to be parallel to the suction panel 16.

The upstream electrode 71 may be disposed between the suction panel 16 and the discharge electrode 61. The suction panel 16 and the upstream electrode 71 and the discharge electrode 61 may be disposed along the first direction F.

The upstream electrode 71 may include an electrode member 72 and a hollow 75. The hollow 75 may be located substantially at the center of the upstream electrode 71 with respect to the second direction. An approximate center of the hollow 75 may be disposed in a position corresponding to the discharge electrode 61 with respect to the first direction F.

The electrode member 72 may form an outer circumference of the hollow 75. The electrode member 72 may extend toward the second direction.

A part or all of the electrode member 72 may include a conductive material. A part or all of the electrode member 72 may include a metal. At least a portion of the electrode member 72 may include a metal or a conductive material having electrical characteristics similar to a metal.

The upstream electrode 71 may include a first upstream electrode 71a and a second upstream electrode 71b. The first upstream electrode 71a may be disposed to correspond to the first discharge electrode 61a, and the second upstream electrode 71b may be disposed to correspond to the second discharge electrode 61b. A center of the first upstream electrode 71a with respect to the second direction may be disposed in a position corresponding to the first discharge electrode 61a along the first direction F. A center of the second upstream electrode 71b with respect to the second direction may be disposed in a position corresponding to the second discharge electrode 61b along the first direction F.

In this drawing, six upstream electrodes 71 are illustrated as an example, but the number of upstream electrodes 71 is not limited thereto. The number of upstream electrodes 71 may be provided to correspond to the number of discharge electrodes 61.

The second upstream electrode 71b may be disposed adjacent to the first upstream electrode 71a. The second upstream electrode 71b may be spaced apart from the first upstream electrode 71a.

A through hole 76 may be formed between the first upstream electrode 71a and the second upstream electrode 71b. The through hole 76 may extend from an outer circumference of the first upstream electrode 71a to an outer circumference of the second upstream electrode 71b. The through hole 76 may extend from an electrode member 72 of the first upstream electrode 71a to an electrode member 72 of the second upstream electrode 71b. The electrode member 72 of the first upstream electrode 71a and the electrode member 72 of the second upstream electrode 71b may be spaced apart from each other, and the through hole 76 may be formed therebetween.

The first upstream electrode 71a and the second upstream electrode 71b may be provided independently. Each of the first upstream electrode 71a and the second upstream electrode 71b may include an independent electrode member 72.

That is, an empty space may be formed between the first upstream electrode 71a and the second upstream electrode 71b. The upstream electrode 71 includes each upstream electrode 71 corresponding to each discharge electrode 61, and thus when forming an electric field with the discharge electrode 61, it is possible to prevent the electric field from being concentrated on a specific part.

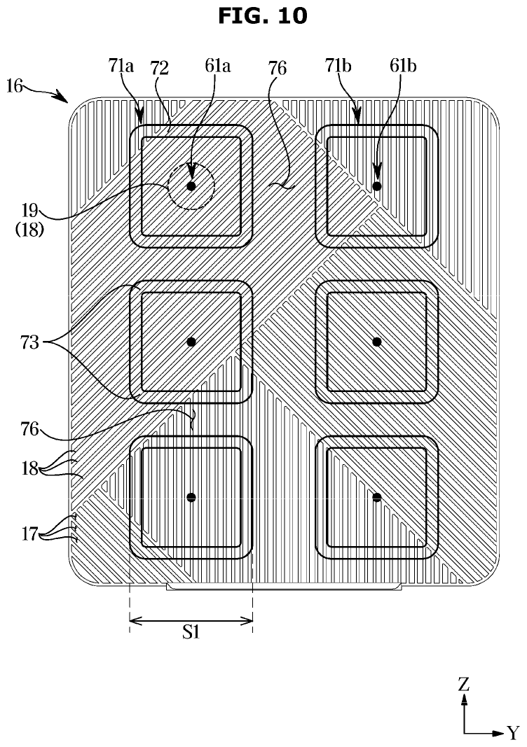

The upstream electrode 71 may have a closed loop shape. The upstream electrode 71 may have a polygonal ring shape. The electrode member 72 may have a polygonal ring shape. The hollow 75 may have a polygonal shape. For example, the upstream electrode 71 may have a rectangular ring shape, and the electrode member 72 and/or the hollow 75 may have a rectangular ring shape. However, the disclosure is not limited thereto, and the upstream electrode 71 may have other shapes. This will be described later with reference to FIGS. 10 to 19.

The electrostatic precipitator 50 may include the dust collector 80. The dust collector 80 may include a first dust collecting electrode 82 and a second dust collecting electrode 83. The first dust collecting electrode 82 and the second dust collecting electrode 83 may be alternately disposed in the second direction. In this drawing, it is illustrated that the first dust collecting electrode 82 and the second dust collecting electrode 83 are alternately arranged along the Y-axis, but the disclosure is not limited thereto. For example, the first dust collecting electrode 82 and the second dust collecting electrode 83 may be alternately arranged along the Z-axis.

The dust collector 80 may be electrically connected to the power supplier 51. A high voltage may be applied to the first dust collecting electrode 82 from the power supplier 51, and the second dust collecting electrode 83 may be grounded. A higher voltage may be applied to the first dust collecting electrode 82 than to the second dust collecting electrode 83 so that the first dust collecting electrode 82 may be formed as a positive (+) electrode, and the second dust collecting electrode 83 may be formed as a negative (−) electrode. An electric field may be formed between the first dust collecting electrode 82 and the second dust collecting electrode 83, and the aerosols charged from the charger 60 may be collected by the collecting electrodes 82 and 83.

The suction panel 16 may be disposed upstream of the electrostatic precipitator 50 with respect to the first direction F, and thus the suction panel 16 may cover the electrostatic precipitator 50 so as to prevent the electrostatic precipitator 50 from being exposed to the outside of the housing 10. The cover portion 18 of the suction panel 16 may cover the electrostatic precipitator 50. The cover portion 18 may be disposed upstream of the electrostatic precipitator 50 with respect to the first direction F. The cover portion 18 may be disposed to cover the electrostatic precipitator 50 with respect to the first direction F. As for the suction panel 16, the cover portion 18 may be formed at a position corresponding to the first direction F from the electrostatic precipitator 50.

Referring to FIG. 5, the upstream electrode 71 may be disposed to be in contact with the suction panel 16. The upstream electrode 71 may maintain a potential difference between a whole of the suction panel 16 and the discharge electrode 61 by being in contact with a part of the suction panel 16. Because the upstream electrode 71 is grounded, the accumulation of ions on the suction panel 16 may be prevented.

A cross section of the upstream electrode 71 in a direction perpendicular to the second direction may have a circular shape. For example, a cross section of the upstream electrode 71, which extends along the Y-axis, with respect to the Z-axis may have a circular shape, and a cross section of the upstream electrode 71, which extends along the Z-axis, with respect to the Y-axis may have a circular shape.

Therefore, in the charging action with the discharge electrode 61, it is possible to prevent a state in which an electric field is concentrated on a sharp specific part so as to generate a spark.

In addition, while inducing corona discharge from the discharge electrode 61, it is possible to prevent the generated ions from being absorbed by the upstream electrode 71 and being lost. The upstream electrode 71 may be formed to have a small surface area so as to allow ions to be easily sprayed out of the housing 10.

The cover portion 18 may include a discharge electrode cover portion 19. The discharge electrode cover portion 19 may be provided at a position facing the discharge electrode 61 with respect to the first direction F. The discharge electrode cover portion 19 may be provided at a position corresponding to the discharge electrode 61 with respect to the second direction. The discharge electrode cover portion 19 may be provided to be spaced apart from the discharge electrode 61 with respect to the first direction F.

Referring to FIG. 6, when a voltage is applied to the discharge electrode 61, corona discharge may occur in the discharge electrode 61. The discharge electrode 61 may generate ions.

For example, if a (−) electrode is applied to the discharge electrode 61 and the discharge electrode 61 generates negative ions, the negative ions may charge the aerosols with a (−) polarity. If a (+) electrode is applied to the discharge electrode 61 and the discharge electrode 61 generates positive ions, the positive ions may charge the aerosols with a (+) polarity. In the drawing, it is illustrated that the discharge electrode 61 generates negative ions, but the disclosure is not limited thereto. That is, the discharge electrode 61 may generate positive ions.

Because the upstream electrode 71 maintains a potential difference with the discharge electrode 61, corona discharge may continue to occur in the discharge electrode 61, and thus ions may be continuously generated. The generated ions may pass through the suction panel 16 and be sprayed out of the housing 10. Ions sprayed outside the housing 10 may charge aerosols in the air outside the housing 10.

That is, because the potential of the upstream electrode 71 is regulated, stable discharge may occur in the discharge electrode 61. Accordingly, the charging efficiency may be increased. In addition, because the discharge characteristics are not easily influenced by the surrounding environment, the degree of freedom in the design of the suction panel 16 may be increased and the degree of freedom in the installation of the air conditioner 1 may be increased. In addition, the air conditioner 1 may have a slim structure.

Meanwhile, because the hollow 75 is formed in the center of the upstream electrode 71 located at the shortest distance from the discharge electrode 61, it is possible to prevent the electric field from being concentrated in the center. Accordingly, the electric field may be uniformly formed over the entire area of the upstream electrode 71. Accordingly, ions may move evenly over the entire area and pass through the entire area of the suction panel 16, thereby being evenly sprayed to the outside of the housing 10.

That is, diffusion charging may occur in a first space 55. The first space 55 may be a space outside the housing 10. The first space 55 may be an external space of the suction panel 16. The first space 55 may be a space disposed upstream of the suction panel 16 with respect to the air flow path. The first space 55 may be a space located in a direction opposite to the first direction F from the suction panel 16.

Ions generated by the discharge electrode 61 may charge the aerosols in the air in the first space 55. The aerosols charged in the first space 55 may pass through the suction panel 16 and be sucked into the housing 10. Thereafter, the charged aerosols may be collected by the dust collector 80 inside the housing 10.

Meanwhile, field charging may also occur inside the housing 10 due to an action between the upstream electrode 71 and the discharge electrode 61. Ions generated from the discharge electrode 61 may charge the aerosols in the air between the discharge electrode 61 and the upstream electrode 71.

That is, field charging may occur in a second space 56. The second space 56 may be a space inside the housing 10. The second space 56 may be an internal space of the suction panel 16. The second space 56 may be a space disposed downstream of the suction panel 16 with respect to the air flow. The second space 56 may be a space located in the first direction F from the suction panel 16.

The second space 56 may be a space between the discharge electrode 61 and the upstream electrode 71. The second space 56 may be a space located upstream of the discharge electrode 61. The second space 56 may be a space located downstream of the upstream electrode 71.

Ions generated from the discharge electrode 61 may charge the aerosols in the air in the second space 56. The aerosols charged in the second space 56 may be collected by the dust collector 80.

That is, some of the ions generated from the discharge electrode 61 may charge aerosols in the air outside the housing 10 in the first space 55, and some of the other ions generated from the discharge electrode 61 may charge aerosols in the air inside the housing 10 in the second space 56.

Therefore, because it is possible to use both the first space 55 and the second space 56, the charging efficiency may be increased. The upstream electrode 71 may enhance diffusion charging in the first space 55 and simultaneously allow electric field charging to occur in the second space 56, thereby increasing the charging efficiency.

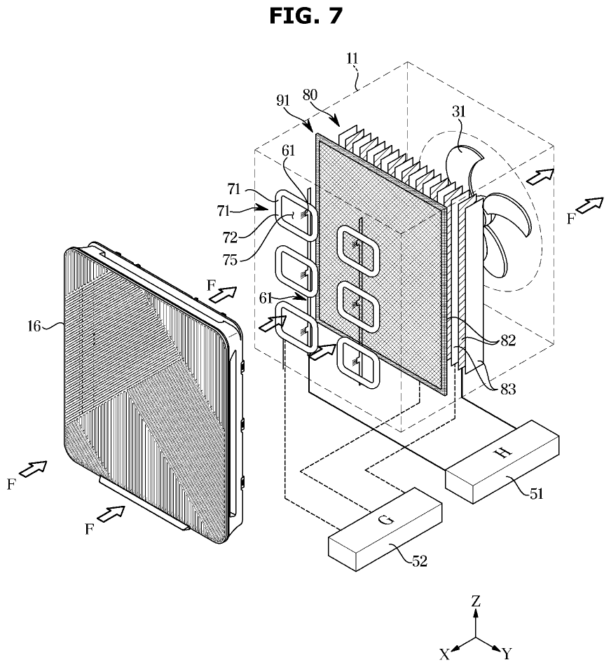

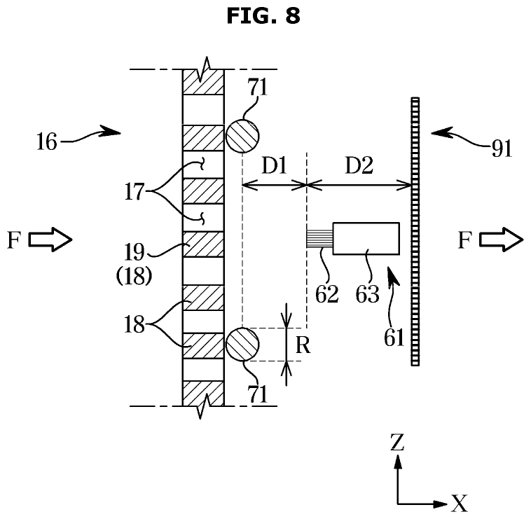

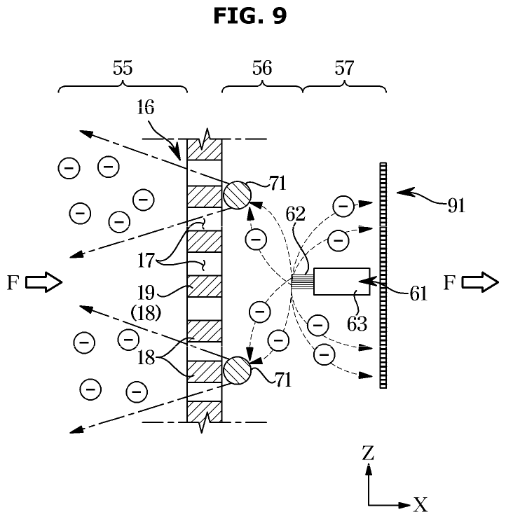

FIG. 7 is a perspective view schematically illustrating the inside of the air conditioner according to an embodiment. FIG. 8 is a cross-sectional view of a portion of the air conditioner according to an embodiment. FIG. 9 is a cross-sectional view illustrating movement of ions in FIG. 8.

In FIG. 7, the cabinet 11 may be indicated by a dotted line and thus a configuration provided inside the housing 10 may be seen.

Referring to FIG. 7, the charger 60 may further include a downstream electrode 91. The downstream electrode 91 may be grounded on the ground 52. The downstream electrode 91 may maintain a voltage of substantially 0V.

That is, the downstream electrode 91 may maintain a lower potential than the discharge electrode 61. Accordingly, a constant potential difference may be formed between the downstream electrode 91 and the discharge electrode 61. An electric field may be formed between the downstream electrode 91 and the discharge electrode 61. High-density ions may be generated between the discharge electrode 61 and the downstream electrode 91.

The downstream electrode 91 may be disposed downstream of the discharge electrode 61 with respect to the first direction F. The downstream electrode 91 may be disposed between the discharge electrode 61 and the dust collector 80. The downstream electrode 91 may be disposed adjacent to the dust collector 80.

The downstream electrode 91 may extend along the second direction in which the upstream electrode 71 extends. The downstream electrode 91 may extend along the Y-axis and/or Z-axis. The downstream electrode 91 may extend along various directions perpendicular to the first direction F on the Y-Z plane.

The downstream electrode 91 may be disposed in parallel to the second direction in which the upstream electrode 71 is disposed. That is, the downstream electrode 91 may be disposed in parallel to the Y-axis and/or the Z-axis. The downstream electrode 91 may be disposed on the Y-Z plane to be parallel to the upstream electrode 71.

The downstream electrode 91 may have a mesh shape. The downstream electrode 91 may have a plate shape. However, it is not limited thereto, and the downstream electrode 91 may have the same shape as the upstream electrode 71.

A part or all of the downstream electrode 91 may include a conductive material. A part or all of the downstream electrode 91 may include a metal. At least a portion of the downstream electrode 91 may include a metal or a conductive material having electrical characteristics similar to a metal.

Referring to FIG. 9, electric field charging may occur due to an action between the downstream electrode 91 and the discharge electrode 61. Ions generated from the discharge electrode 61 may charge aerosols in the air between the discharge electrode 61 and the downstream electrode 91.

That is, electric field charging may occur in a third space 57. The third space 57 may be a space inside the housing 10. The third space 57 may be an internal space of the suction panel 16. The third space 57 may be a space disposed downstream of the suction panel 16 with respect to the air flow path. The third space 57 may be a space located in the first direction F from the suction panel 16.

The third space 57 may be a space between the discharge electrode 61 and the downstream electrode 91. The third space 57 may be a space located downstream of the discharge electrode 61. The third space 57 may be a space located upstream of the downstream electrode 91.

Ions generated from the discharge electrode 61 may charge aerosols in the air in the third space 57. The aerosols charged in the third space 57 may be collected by the dust collector 80.

That is, some of the ions generated from the discharge electrode 61 may charge the aerosols in the air outside the housing 10 in the first space 55, and some of the other ions generated from the discharge electrode 61 may charge the aerosols in the air inside the housing 10 in the second space 56 and/or the third space 57. That is, because the aerosols are charged even in the third space 57, the residence time of the aerosols may become longer and thus high charging efficiency may be obtained.

Accordingly, because it is possible to use all of the first space 55, the second space 56, and the third space 57, the charging efficiency may be increased. The downstream electrode 91 may increase the charging efficiency by causing electric field charging in the third space 57. In addition, the air conditioner 1 may have a slim structure.

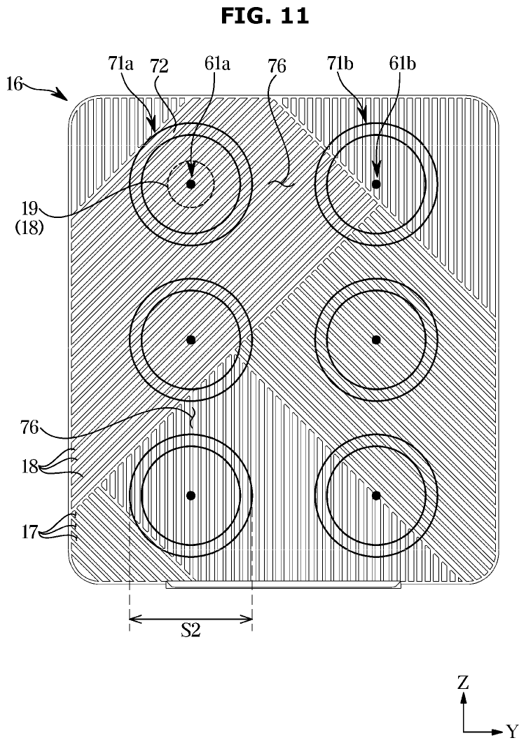

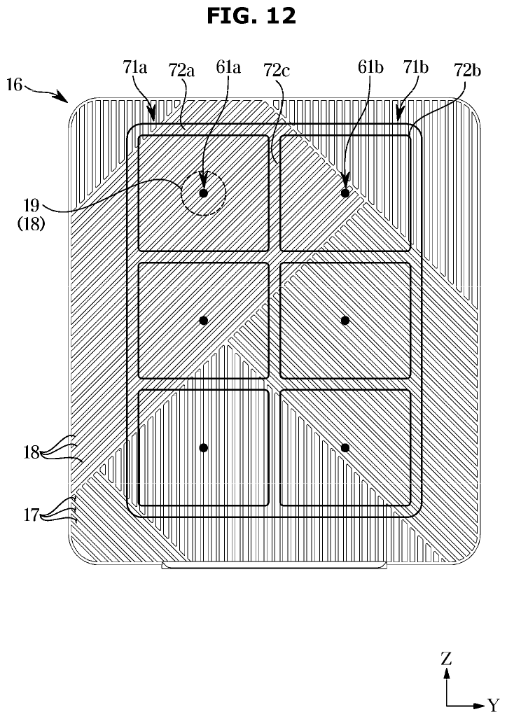

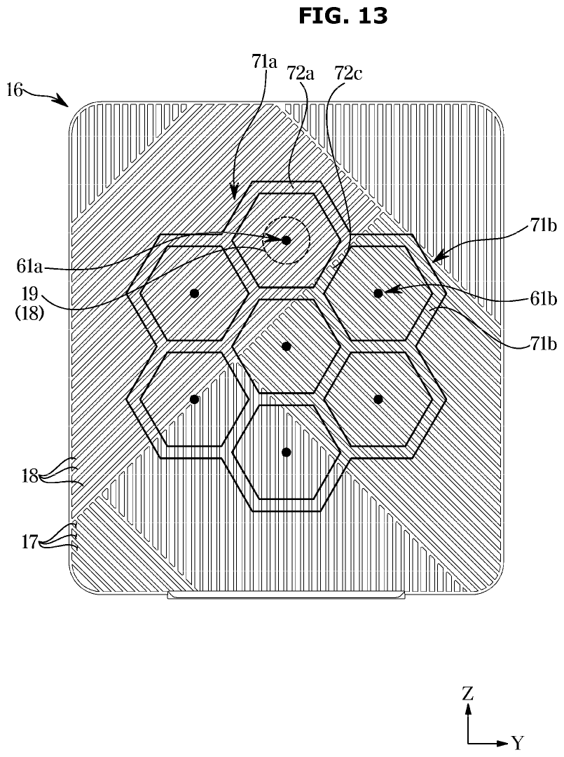

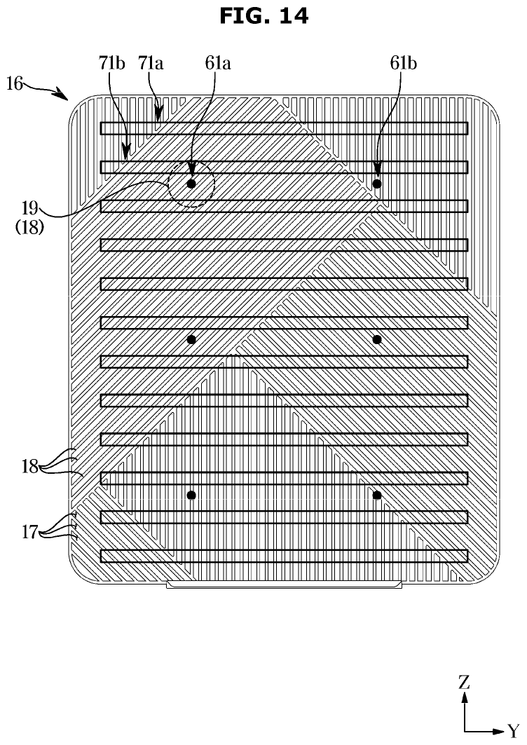

FIG. 10 is a rear-view illustrating an air conditioner according to an embodiment. FIG. 11 is a rear-view illustrating an air conditioner according to an embodiment. FIG. 12 is a rear-view illustrating an air conditioner according to an embodiment. FIG. 13 is a rear-view illustrating an air conditioner according to an embodiment. FIG. 14 is a rear-view illustrating an air conditioner according to an embodiment.

The suction panel 16 may include a cover portion 18. The cover portion 18 may include a discharge electrode cover portion 19. The discharge electrode cover portion 19 may be an area, which is provided in a position corresponding to the discharge electrode 61 with respect to the first direction F, in the cover portion 18. The discharge electrode cover portion 19 may be an area adjacent to the discharge electrode 61. The discharge electrode cover portion 19 may be an area covering the discharge electrode 61.

The discharge electrode cover portion 19 may form a partial area of the cover portion 18. The discharge electrode cover portion 19 may be provided in the same shape as other areas of the cover portion 18. That is, the discharge electrode cover portion 19 may be provided without a hole separately formed to expose the discharge electrode 61 to the outside. The discharge electrode cover portion 19 may be formed by being connected to other areas of the cover portion 18, and thus the cover portion 18 may be provided in a uniform pattern over the entire area. Accordingly, aesthetics may be improved by increasing the degree of freedom in the design of the suction panel 16.

Referring to FIG. 10, the upstream electrode 71 may have a square ring shape. The electrode member 72 may have a square ring shape, and the hollow 75 may have a square shape. The discharge electrode 61 may be disposed in a position corresponding to approximately the center of the upstream electrode 71.

The upstream electrode 71 may be provided to maximize an area covering the suction panel 16 in order to maintain an electric potential of the suction panel 16.

An edge 73 of the electrode member 72 may have a round shape. Accordingly, when the discharge electrode 61 generates ions, it is possible to prevent a state in which an electric field is concentrated on a sharp specific part so as to generate a spark.

Meanwhile, referring to FIG. 8, R may be a diameter of a cross section of the upstream electrode 71. That is, R may be a diameter of a cross section of the upstream electrode 71 in a direction perpendicular to the second direction. R may be a diameter of a circle that is a cross section of the upstream electrode 71.

D1 may be a distance between the upstream electrode 71 and the discharge electrode 61. D1 may be a distance between the center of the upstream electrode 71 in the second direction and one end of the brush 62 of the discharge electrode 61. D1 may be a distance between the upstream electrode 71 and the discharge electrode 61 with respect to the first direction F. D1 may be a vertical distance between the upstream electrode 71 and the discharge electrode 61.

D2 may be a distance between the downstream electrode 91 and the discharge electrode 61. D2 may be a distance between one end of the brush 62 and the downstream electrode 91 that correspondingly disposed toward the one end of the brush 62. D2 may be a distance between the downstream electrode 91 and the discharge electrode 61 with respect to the first direction F. D2 may be a vertical distance between the downstream electrode 91 and the discharge electrode 61.

At this time, a relationship between R and D1 may be provided in a range of 0.06<R (mm)/D1 (mm)<0.1. A relationship between D2 and the first voltage may be provided in a range of 2<D2 (mm)/first voltage (kV)<8. A charging efficiency of aerosols in the air may be improved under these conditions. However, the disclosure is not limited thereto.

Referring to FIG. 10, S1 may be a length of a side of the upstream electrode 71. S1 may be a length of a side when the upstream electrode 71 is provided in a rectangular ring shape. 51 may be a length at which the electrode member 72 of the upstream electrode 71 extends in the second direction.

At this time, a relationship between 51 and D1 may be provided in a range of 2.5<S1 (mm)/D1 (mm)<6. A relationship between D1 and the first voltage may be provided in the range of 3<D1 (mm)/first voltage (kV)<10. A charging efficiency of aerosols in the air may be improved under these conditions. However, the disclosure is not limited thereto.

Referring to FIG. 11, the upstream electrode 71 may have a circular ring shape. The electrode member 72 may have a circular ring shape, and the hollow 75 may have a circular shape. The discharge electrode 61 may be disposed in a position corresponding to approximately the center of the upstream electrode 71.

S2 may be a length of the diameter of the upstream electrode 71. S2 may be a length of a diameter when the upstream electrode 71 is provided in a circular ring shape.

At this time, a relationship between S2 and D1 may be provided in a range of 2.5<S2 (mm)/D1 (mm)<6. A relationship between D1 and the first voltage may be provided in a range of 3<D1 (mm)/first voltage (kV)<10. However, the disclosure is not limited thereto.

Referring to FIGS. 12 and 13, the upstream electrode 71 may include a first upstream electrode 71a disposed toward the first discharge electrode 61a and a second upstream electrode 71b disposed toward the second discharge electrode 61b and disposed adjacent to the first upstream electrode 71a.

The second upstream electrode 71b may extend from the first upstream electrode 71a. An electrode member 72b of the second upstream electrode 71b may extend from an electrode member 72a of the first upstream electrode 71a. The first upstream electrode 71a and the second upstream electrode 71b may share an electrode member 72c. The first upstream electrode 71a and the second upstream electrode 71b may share at least a portion of the electrode member 72.

The first upstream electrode 71a and the second upstream electrode 71b may be integrally formed. The first upstream electrode 71a and the second upstream electrode 71b may be formed in a lattice shape. Referring to FIG. 12, the upstream electrode 71 may be formed in a quadrangular lattice shape, and referring to FIG. 13, the upstream electrode 71 may be formed in a hexagonal lattice shape. In addition, the upstream electrode 71 may be formed in various polygonal or circular shapes to cover the discharge electrode 61.

Referring to FIG. 14, the upstream electrode 71 may have a cylindrical shape. The upstream electrode 71 may have a rod shape.

The electrode member 72 may extend to correspond to the length of the suction panel 16. However, the disclosure is not limited thereto, and the length of the electrode member 72 extending along the suction panel 16 may be implemented in various ways.

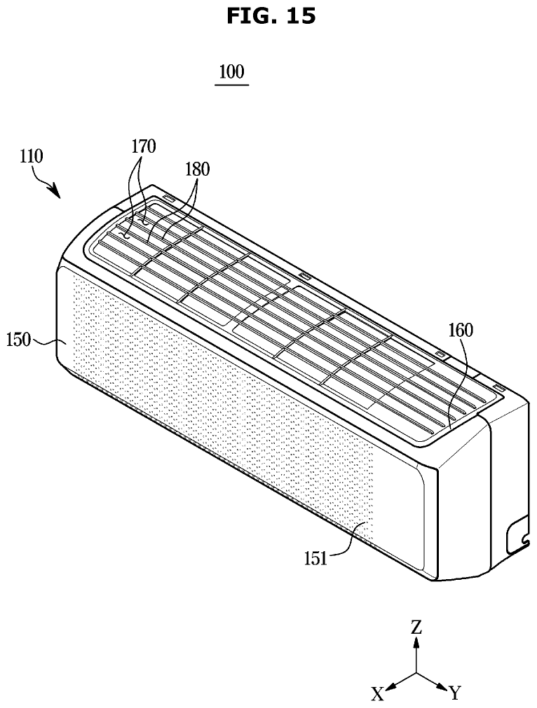

FIG. 15 is a perspective view illustrating an air conditioner according to an embodiment.

An air conditioner 100 may include a wall-mounted air conditioner 100 installed on a wall. The air conditioner 100 may include a housing 110. The housing 110 may have a substantially rectangular parallelepiped shape.

The housing 110 may include a suction panel 160 provided to allow outside air to flow into the air conditioner 100. The housing 110 may include a discharge panel 150 provided to discharge air, which is sucked into the housing 110 through the suction panel 160, to an outside.

In this drawing, it is illustrated that the suction panel 160 and the discharge panel 150 are disposed in a vertical direction and thus a first direction F in which air flows may be a direction from top to bottom. That is, the first direction F may be a direction along the Z-axis.

The suction panel 160 may extend along a second direction. The second direction may be a direction along the Y-axis.

The suction panel 160 may include a cover portion 180 and an opening 170. The cover portion 180 may include a plurality of ribs. The plurality of ribs may extend along various directions.

The cover portion 180 may be formed along the second direction. The cover portion 180 may have a linear shape. The cover portion 180 may be elongated in the left and right direction. The cover portion 180 may extend in a straight line. The cover portion 180 may extend along the Y-axis.

The cover portion 180 may be provided in plurality. The cover portions 180 may be disposed spaced apart from each other. The cover portions 180 may be spaced apart along the X-axis. However, the disclosure is not limited thereto, and the cover portion 180 may be provided as a single piece.

The opening 170 may be formed to correspond to the cover portion 180. The opening 170 may be an opening formed between the plurality of ribs of the cover portion 180.

The discharge panel 150 may include a discharge port 151. The discharge port 151 may be provided in plurality and have a circular shape.

However, the disclosure is not limited thereto, and the discharge port of the air conditioner 100 may be provided at a lower portion of the housing 110.

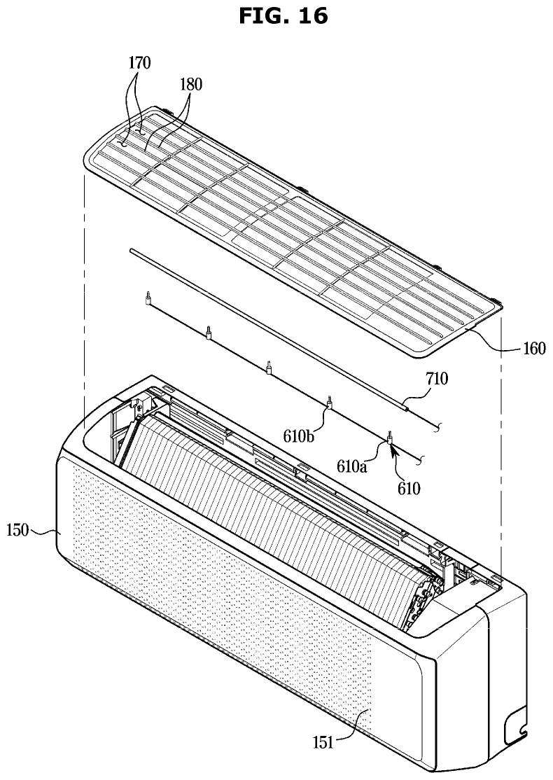

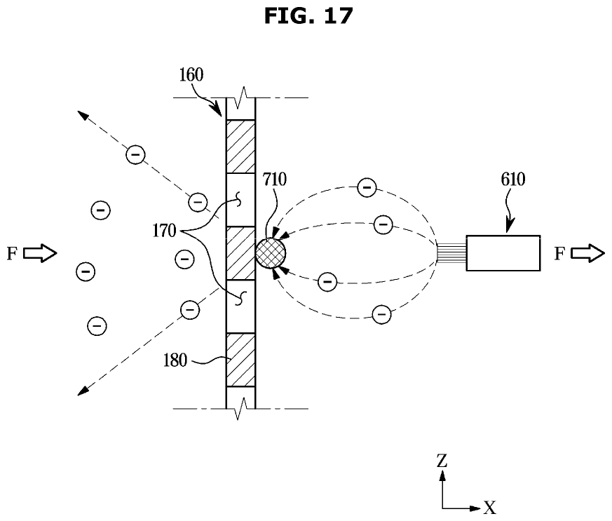

FIG. 16 is a perspective view schematically illustrating an inside of the air conditioner according to an embodiment. FIG. 17 is a cross-sectional view illustrating movement of ions in a portion of the air conditioner according to an embodiment.

A discharge electrode 610 may include a first discharge electrode 610a and a second discharge electrode 610b spaced apart from the first discharge electrode 610a.

The first discharge electrode 610a and the second discharge electrode 610b may be arranged along an extension direction of the cover portion 180 and/or the opening 170. The first discharge electrode 610a and the second discharge electrode 610b may be spaced apart from each other along the extension direction of the cover portion 180 and/or the opening 170. The first discharge electrode 610a and the second discharge electrode 610b may be arranged along the Y-axis.

An upstream electrode 710 may be provided in a shape corresponding to the cover portion 180 and/or the opening 170. The upstream electrode 710 may extend along the direction in which the cover portion 180 extends. The upstream electrode 710 may extend along the Y-axis.

The upstream electrode 710 may be provided to cover the first discharge electrode 610a and the second discharge electrode 610b. The upstream electrode 710 may extend along the arrangement direction of the first discharge electrode 610a and the second discharge electrode 610b.

The upstream electrode 710 may have a cylindrical shape. The upstream electrode 710 may have a rod shape. The upstream electrode 710 may have a linear shape.

The upstream electrode 710 may be disposed on the Z-axis with the discharge electrode 610. The cover portion 180, the upstream electrode 710, and the discharge electrode 610 may be arranged in a line.

Because the upstream electrode 710 is formed in a linear shape, the electrostatic precipitator may have a slim design even when the cover portion 180 and/or the opening 170 have a linear shape.

In this drawing, the plurality of discharge electrodes 610a and 610b arranged along the arrangement direction of the cover 180 and/or the opening 170, and a single upstream electrode 710 provided to cover the plurality of discharge electrodes 610a and 610b are illustrated as an example, but is not limited thereto.

For example, the discharge electrode 610 may include a third discharge electrode (not shown) spaced apart from the first discharge electrode 610a along the X-axis. The third discharge electrode (not shown) may be arranged along the arrangement direction of the plurality of cover portions 180 and/or the opening 170 from the first discharge electrode 610a. The upstream electrode 710 may include an upstream electrode (not shown) covering the third discharge electrode (not shown). The upstream electrode 710 may be provided in plurality.

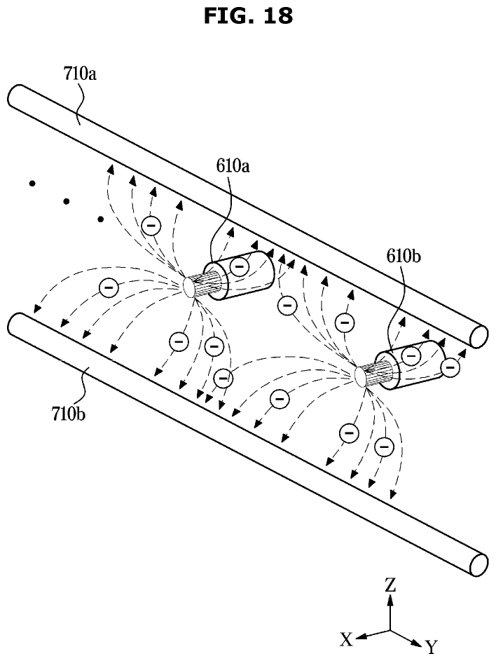

FIG. 18 is a perspective view schematically illustrating the inside of the air conditioner according to an embodiment.

The upstream electrode 710 may include a first upstream electrode 710a and a second upstream electrode 710b spaced apart from the first upstream electrode 710a.

The first upstream electrode 710a and the second upstream electrode 710b may be arranged to allow the discharge electrode 610 to be interposed therebetween. That is, the first upstream electrode 710a and the second upstream electrode 710b may be alternately disposed with the discharge electrode 610 interposed therebetween.

The first upstream electrode 710a and the second upstream electrode 710b may be arranged in parallel with each other. The first upstream electrode 710a and the second upstream electrode 710b may be arranged along the X-axis.

A distance between the first upstream electrode 710a and the discharge electrode 610 may be the same as a distance between the second upstream electrode 710b and the discharge electrode 610. However, the disclosure is not limited thereto, and the distance between the first upstream electrode 710a and the discharge electrode 610 may be greater or less than the distance between the second upstream electrode 710b and a discharge electrode 610.

Ions generated from the discharge electrode 610 may be directed to the first upstream electrode 710a or the second upstream electrode 710b.

Ions generated from the discharge electrode 610 may move to the first upstream electrode 710a or the second upstream electrode 710b, and thus the ions may be emitted into a wider space. Accordingly, ions may be uniformly sprayed out of the housing 110.

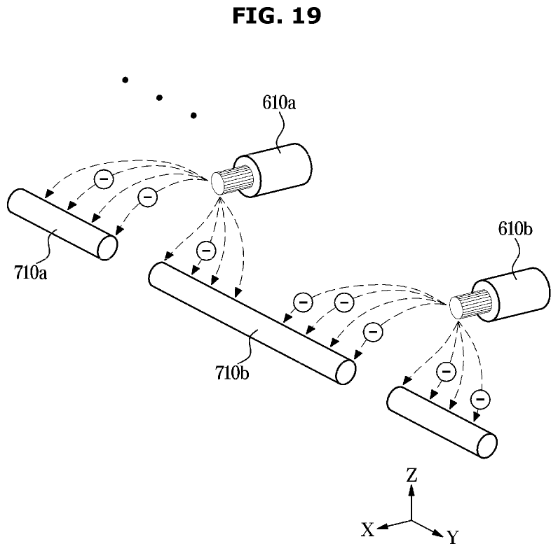

FIG. 19 is a perspective view schematically illustrating the inside of the air conditioner according to an embodiment.

The upstream electrode 710 may include the first upstream electrode 710a and the second upstream electrode 710b spaced apart from the first upstream electrode 710a.

The first upstream electrode 710a and the second upstream electrode 710b may be spaced apart from each other along the extension direction of the cover portion 180. The first upstream electrode 710a and the second upstream electrode 710b may be arranged along the Y-axis.

The first upstream electrode 710a and the second upstream electrode 710b may be arranged to allow the discharge electrode 610 to be interposed therebetween.

Ions generated from the discharge electrode 610 may move to the first upstream electrode 710a or the second upstream electrode 710b. In addition, because an empty space is formed in front of the discharge electrode 610, ions generated from the discharge electrode 610 may be more easily sprayed toward the outside of the housing 110.

The embodiments of FIGS. 11 to 19 may be combined with the embodiments of FIGS. 4 to 9.

Various embodiments of the disclosure may provide an electrostatic precipitator that includes a dust collector disposed downstream of the discharge electrode with respect to the first direction to collect the charged aerosols. The suction panel may include a cover portion disposed toward the electrostatic precipitator with respect to the first direction to prevent the electrostatic precipitator from being exposed to the outside of the housing. The cover portion may include a discharge electrode cover portion provided at a position corresponding to the discharge electrode with respect to the first direction.

Various embodiments of the disclosure may provide an electrostatic precipitator that includes a discharge electrode disposed in an aft flow path and configured to generate ions in a direction opposite to one direction in which air flows from upstream to downstream, and an upstream electrode disposed upstream of the discharge electrode with respect to the one direction. The upstream electrode may be grounded to maintain a potential difference with the discharge electrode, and disposed toward the discharge electrode with respect to the one direction. The electrostatic precipitator may include a downstream electrode disposed downstream of the discharge electrode with respect to the one direction. The downstream electrode may be grounded to maintain a potential difference with the discharge electrode, and may be disposed toward the discharge electrode with respect to the one direction.

The upstream electrode may include a hollow and an electrode member forming an outer circumference of the hollow and disposed toward the discharge electrode with respect to the one direction.

The electrode member may extend to have a polygonal ring shape.

The discharge electrode may include a first discharge electrode, and a second discharge electrode disposed spaced apart from the first discharge electrode along the second direction. The upstream electrode may include a first upstream electrode disposed to allow a center of the first upstream electrode with respect to the other direction, which is perpendicular to the one direction, to be disposed toward the first discharge electrode along the one direction, and a second upstream electrode disposed to allow a center of the second upstream electrode with respect to the other direction to be disposed toward the second discharge electrode along the one direction, the second upstream electrode spaced apart from and disposed adjacent to the first upstream electrode. The electrostatic precipitator may further include a through hole extending from an electrode member of the first upstream electrode to an electrode member of the second upstream electrode.

As is apparent from the above description, ions generated by a discharge electrode may be sprayed to an outside of a housing to improve an air charging efficiency.

Further, a charging efficiency of air outside and inside a housing may be improved.

Further, aesthetics may be improved by increasing a degree of freedom in design of an air conditioner.

Further, a degree of freedom in installation of an air conditioner may be increased.

Although a few embodiments of the disclosure have been shown and described, it would be appreciated by those skilled in the art that changes may be made in these embodiments without departing from the principles and spirit of the disclosure, the scope of which is defined in the claims and their equivalents.

What is claimed is:

1. An air conditioner comprising:
a housing including a suction panel;
a fan disposed inside the housing and configured to generate an air flow which is sucked into the housing through the suction panel to flow in a first direction from upstream to downstream, the suction panel being perpendicular to the first direction; and
an electrostatic precipitator disposed inside the housing and including:
a discharge electrode configured to receive a voltage and to generate ions toward the suction panel, and
an upstream electrode disposed upstream of the discharge electrode with respect to the first direction, grounded to form an electric field with the discharge electrode, and disposed between the discharge electrode and the suction panel,
wherein at least a portion of the ions generated from the discharge electrode are passed through the suction panel so as to charge aerosols in air outside the housing.

2. The air conditioner of claim 1, wherein
the upstream electrode extends along a plane perpendicular to the first direction to at least partially cover the suction panel.

3. The air conditioner of claim 1, wherein
the upstream electrode includes:
a hollow, and
an electrode member forming an outer circumference of the hollow and having a length extending along the plane perpendicular to the first direction.

4. The air conditioner of claim 3, wherein
the discharge electrode includes:
a first discharge electrode, and
a second discharge electrode spaced apart from the first discharge electrode in a second direction perpendicular to the first direction,
the upstream electrode includes:
a first upstream electrode disposed so that a center of the first upstream electrode is disposed in a position corresponding to the first discharge electrode along the first direction, and
a second upstream electrode disposed so that a center of the second upstream electrode is disposed in a position corresponding to the second discharge electrode along the first direction, the second upstream electrode being spaced apart from and disposed adjacent to the first upstream electrode, and
the air conditioner further comprises:
a through hole extending between the first upstream electrode and the second upstream electrode.

5. The air conditioner of claim 3, wherein
the discharge electrode includes:
a first discharge electrode, and
a second discharge electrode spaced apart from the first discharge electrode in a second direction perpendicular to the first direction,
the upstream electrode includes:
a first upstream electrode disposed so that a center of the first upstream electrode is disposed in a position corresponding to the first discharge electrode along the first direction, and
a second upstream electrode disposed so that a center of the second upstream electrode is disposed in a position corresponding to the second discharge electrode along the first direction, the second upstream electrode disposed adjacent to the first upstream electrode, and
the electrode member of the second upstream electrode extends from the electrode member of the first upstream electrode.

6. The air conditioner of claim 3, wherein
the electrode member is configured in a polygonal ring shape.

7. The air conditioner of claim 3, wherein
the electrode member is configured in a circular ring shape.

8. The air conditioner of claim 3, wherein
a cross section of the electrode member has a circular shape.

9. The air conditioner of claim 1, wherein
the upstream electrode is configured in a rod shape.

10. The air conditioner of claim 1, wherein
the upstream electrode is disposed to be in contact with the suction panel.

11. The air conditioner of claim 1, wherein
the electrostatic precipitator further includes a downstream electrode disposed downstream of the discharge electrode with respect to the first direction, and
the downstream electrode is grounded to form an electric field with the discharge electrode.

12. The air conditioner of claim 11, wherein
the downstream electrode has a mesh shape.

13. The air conditioner of claim 11, wherein:
at least a portion of the downstream electrode includes a conductive material.

14. The air conditioner of claim 1, wherein:
the suction panel includes a cover portion disposed toward the electrostatic precipitator to prevent the electrostatic precipitator from being exposed to the outside of the housing.

15. The air conditioner of claim 14, wherein:
the cover portion includes a discharge electrode cover portion provided at a position corresponding to the discharge electrode with respect to the first direction.
